(19) United States
(12) Patent Application Publication
(10) Pub. No.: US 2014/0279131 A1
(43) Pub. Date: Sep. 18, 2014

(54) ON-LINE MARKETPLACE SERVICE

(71) Applicants: Robert Edward Sullivan, Wellesley, MA (US); James T. Sullivan, Cambridge, MA (US)

(72) Inventors: Robert Edward Sullivan, Wellesley, MA (US); James T. Sullivan, Cambridge, MA (US)

(21) Appl. No.: 14/212,800

(22) Filed: Mar. 14, 2014

Related U.S. Application Data
(60) Provisional application No. 61/783,736, filed on Mar. 14, 2013.

(51) Int. Cl. G06Q 30/06

(52) U.S. Cl. CPC G06Q 30/0601
USPC 705/26.1

(57) ABSTRACT

Techniques for operating a marketplace service to manage on-line marketplaces so as to limit access to information regarding distribution of items (e.g., sales of goods/services). The marketplace service may manage multiple on-line marketplaces, with each on-line marketplace enabling a user to distribute to other users of that on-line marketplace information regarding items that the user has made available for distribution to the other users with access to that marketplace. In some embodiments, an on-line marketplace may be associated with a relationship external to the marketplace service, and the marketplace service may limit access to the on-line marketplace only to users who share that relationship. These embodiments may therefore enable users to exclusively distribute, via the service, information regarding a sale of goods or services to users who have a relationship external to the marketplace service, thereby limiting how widely information regarding the sale is distributed.

### CROSS-REFERENCE TO RELATED APPLICATIONS

The present application claims priority under 35 U.S.C. §119(e) to U.S. Provisional Patent Application Ser. No. 61/783,736, titled “ON-LINE MARKETPLACE SERVICE” and filed on March 14, 2013, the entirety of which is incorporated herein by reference.

### SUMMARY

In one embodiment, there is provided a method of managing distribution of an item via two or more on-line marketplaces of a marketplace service. The marketplace service manages at least a first plurality of on-line marketplaces and has a plurality of users. The method comprises operating at least one processor to store in at least one data store, separately for each on-line marketplace of the first plurality of on-line marketplaces, data identifying users of the plurality of users that are permitted to access that on-line marketplace, and receive first input from a first user of the plurality of users identifying a first item to be listed for distribution via the marketplace service and a first on-line marketplace of the first plurality of on-line marketplaces in which to list the first item for distribution. The method further comprises operating the at least one processor to receive second input from the first user requesting creation of a second on-line marketplace. The second input identifies that at least one second item is to be listed for distribution in the second on-line marketplace and identifies at least one person that does not have access to the first on-line marketplace and that is to be permitted to access the second on-line marketplace. The at least one second item comprises the first item. In the method, receiving the second input from the first user comprises outputting for display to the first user a listing of one or more second items that the first user has input to the marketplace service to list for distribution via the marketplace service via one or more of the first plurality of marketplaces, and receiving a selection from the first user of the at least one second item from the one or more second items included in the listing. The method further comprises operating the at least one processor to store, in the at least one data store, a record for the first item that identifies both the first on-line marketplace and the second on-line marketplace, and, in response to user action relating to the first item within the first on-line marketplace or the second on-line marketplace, update the record in the at least one data store.

In another embodiment, there is provided at least one non-transitory computer-readable storage medium having encoded thereon executable instructions that, when executed by at least one computing device, cause the at least one computing device to carry out a method of managing distribution of an item via two or more on-line marketplaces of a marketplace service. The marketplace service manages at least a first plurality of on-line marketplaces and the marketplace service has a plurality of users. The method comprises storing in at least one data store, separately for each on-line marketplace of the first plurality of on-line marketplaces, data identifying users of the plurality of users that are permitted to access that on-line marketplace, receiving first input from a first user of the plurality of users identifying a first item to be listed for distribution via the marketplace service and a first on-line marketplace of the first plurality of on-line marketplaces in which to list the first item for distribution, and receiving second input from the first user requesting creation of a second on-line marketplace. The second input identifies that at least one second item is to be listed for distribution in the second on-line marketplace and identifies at least one person that does not have access to the first on-line marketplace and that is to be permitted to access the second on-line marketplace. The at least one second item comprises the first item. In the method, receiving the second input from the first user comprises outputting for display to the first user a listing of one or more second items that the first user has input to the marketplace service to list for distribution via the marketplace service via one or more of the first plurality of marketplaces, and receiving a selection from the first user of the at least one second item from the one or more second items included in the listing. The method further comprises storing, in the at least one data store, a record for the first item that identifies both the first on-line marketplace and the second on-line marketplace, and, in response to user action relating to the first item within the first on-line marketplace or the second on-line marketplace, updating the record in the at least one data store.

In a further embodiment, there is provided a method of managing distribution of an item via one or more on-line marketplaces of a marketplace service. The marketplace service manages at least a plurality of on-line marketplaces managed by a marketplace service. The marketplace service has a plurality of users. The method comprises operating at least one processor to receive first input from a first user identifying a plurality of items to be distributed via the marketplace service in one or more of the plurality of on-line marketplaces, the plurality of items comprising a first item, a second item, and a third item, and receiving second input from the first user requesting creation of a first on-line marketplace. The second input identifies that the first item and the second item are to be listed for distribution in the first on-line marketplace and identifies at least one first person who is to be permitted access to the first on-line marketplace following creation. In the method, receiving the second input from the first user comprises outputting for display to the first user a listing of the plurality of items that the first user has listed for distribution via the marketplace service, and receiving a first selection from the first user of the at least the first item and the second item from the plurality of items included in the listing. The method further comprises operating the at least one processor to receive third input from the first user requesting creation of a second on-line marketplace. The third input identifies that the second item and the third item are to be listed for distribution in the second on-line marketplace and identifies at least one second person who is to be permitted access to the second on-line marketplace following creation. In the method, receiving the second input from the first user comprises outputting for display to the first user the listing of the plurality of items that the first user has listed for distribution via the marketplace service, and receiving a second selection from the first user of the at least the second item and the third item from the plurality of items included in the listing. The method further comprises operating the at least one processor to send a first message to the at least one first person inviting the at least one first person to access the first on-line marketplace, send a second message to the at least one second person inviting the at least one second person to access the second on-line marketplace, store, in at least one data store, a record for the second item that identifies both the first on-line marketplace and the second on-line marketplace, and, in response to user action relating to the second item within the first on-line marketplace or the second on-line marketplace, update the record in the at least one data store.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates components and steps included in some embodiments of a sign-up process for users to register with an illustrative marketplace service;

FIG. 2 illustrates components and steps included in some embodiments of a sign-in process for users of an illustrative marketplace service;

FIG. 3 illustrates components and steps included in some embodiments of a process for creating an on-line marketplace using an illustrative marketplace service;

FIG. 3.1 illustrates components and steps included in some embodiments of a process for creating a personalized on-line marketplace using an illustrative marketplace service;

FIG. 3.2 illustrates components and steps included in some embodiments of another process for creating a personalized on-line marketplace using an illustrative marketplace service;

FIG. 4.0 illustrates components and steps included in some embodiments of a process for administering marketplaces using an illustrative marketplace service;

FIG. 5.0 illustrates components and steps included in some embodiments of a process for listing an item for distribution via one or more marketplaces;

FIG. 6.0 illustrates components and steps included in some embodiments of a process for transmitting notifications to users of an illustrative marketplace service;

FIG. 7.0 illustrates some exemplary types of on-line marketplaces that may be administered using an illustrative marketplace service;

FIG. 7.1 illustrates an example of one type of on-line marketplace that may be administered using an illustrative marketplace service;

FIG. 7.2 illustrates an example of another type of on-line marketplace that may be administered using an illustrative marketplace service;

FIG. 7.3 illustrates an example of a third type of on-line marketplace that may be administered using an illustrative marketplace service;

FIG. 7.4 illustrates an example of a further type of on-line marketplace that may be administered using an illustrative marketplace service;

FIG. 7.5 illustrates an example of a fifth type of on-line marketplace that may be administered using an illustrative marketplace service;

FIG. 7.6 illustrates an example of another type of on-line marketplace that may be administered using an illustrative marketplace service;

FIG. 8.0 illustrates an example of items a user may list for distribution via one or more on-line marketplaces as well as on-line marketplaces a user may access in an illustrative marketplace service; and

FIG. 9.0 illustrates an exemplary computing device with which some embodiments may operate.

### DETAILED DESCRIPTION

Described herein are techniques for operating a marketplace service, hosted on one or more servers and accessible via one or more web pages, to manage on-line marketplaces in a manner that limits access to information regarding distribution of items (e.g., sales of goods and services, including rental or lease of goods or services). The marketplace service may manage multiple on-line marketplaces, with each on-line marketplace enabling a user to distribute to other users of that on-line marketplace information regarding items that the user has made available for distribution to the other users with access to that marketplace. Multiple users may be associated with an on-line marketplace to receive information distributed in the on-line marketplace. In some embodiments, an on-line marketplace may be associated with one or more types of relationships external to the marketplace service, and the marketplace service may limit access to the on-line marketplace only to users who share the relationship(s). These embodiments may therefore enable users to exclusively distribute, via the service, information regarding a sale of goods or services to users who have a relationship external to the marketplace service and who are associated with a particular on-line marketplace, thereby limiting how widely information regarding the sale is distributed.

Traditionally, when a person had a good or service they were seeking to sell to others, the person would post information about the good/service as widely as possible, to inform as many other people as possible regarding the sale to try to increase the likelihood of a sale. Multiple on-line services have been created to assist people with widely publicizing sales. These services allow a person to post information about a good or service to a web site and allow all members of the public to view the web site to learn about the good or service. The inventors have recognized and appreciated, however, that widely publicizing sales of goods or services may be disadvantageous in some cases. The inventors have recognized and appreciated, for example, that there may be a problem of trust when a person is selling goods or services directly to another person that may not exist when an established business is a buyer or seller, and that this lack of trust may impede sales. This lack of trust may exist on the part of both the seller and potential buyers. The seller may be wary of unknown buyers who may steal from or injure the buyer, and the buyer may be wary of an unknown seller who may swindle the buyer with a defective good or service. The inventors have recognized and appreciated that this lack of trust may discourage buyers and sellers who do not know each other or have no connection outside of the potential sale from meeting, which discourages sales. The inventors have therefore recognized and appreciated that on-line services that widely publicize information regarding sales, and connect unknown buyers and sellers, may not actually assist users with selling goods or services.

Accordingly, in some embodiments, technological measures are used to create trust between sellers and potential buyers. More particularly, in some embodiments, technological measures are used to distribute information regarding sales of goods and/or services from sellers to buyers who the seller may have a pre-existing relationship with or that the seller may otherwise be pre-disposed to trust. In some embodiments, the technological measures are implemented by one or more servers executing computer-executable instructions. The servers may, through executing the instructions, host a marketplace service that manages one or more on-line marketplaces, each of which may have limited membership to users who have an existing relationship.

Existing relationships may be relationships that connect users in a way external to the marketplace service. Existing relationships may include relationships that identify a way in which two people know each other external to the marketplace system, such as social connections between users. Social connections between users may include being members of a same social circle, such that the users are friends or share friends, or being family members. Existing relationships may also include relationships between users that may not know each other but that share one or more common characteristics. Common characteristics that may be shared by users may include characteristics of users' identity, preferences, or behaviors. Characteristics of a user may include immutable or variable characteristics of the user, such as demographics of the user. Examples of characteristics of a user include living in a particular area or being related to an organization. Users may be related to an organization in any suitable manner, including being employed by, enrolled in or attending gatherings arranged by, members of, and/or customers of the organization. Organizations to which users may be related may be for-profit organizations or non-profit organizations, such as businesses, residential associations, educational institutions, hobby groups, or any other suitable organization. Such organizations may or may not be legal entities.

In some embodiments, a user may be eligible to be associated with an on-line marketplace when the user has the existing relationship(s) with which the on-line marketplace is associated. For example, when the relationship with which an on-line marketplace is associated is that users are employed by the same company, a user may be eligible to be associated with the on-line marketplace when the user is employed by the company. In some embodiments, a user may be able to be associated with one on-line marketplace managed by the marketplace service, while in other embodiments the marketplace service may enable a user to be associated with any number of on-line marketplaces with which the user is eligible to be associated.

A marketplace service may, in some embodiments, carry out an association process to associate a user with an on-line marketplace. The marketplace service may perform the process in response to receiving a request from a user to join an on-line marketplace. As part of the association process, the marketplace service may confirm that the user meets one or more criteria associated with the marketplace. For example, the marketplace service may request from the user a demonstration that the user has existing relationship(s) with which the on-line marketplace is associated. The marketplace service may be adapted to receive and evaluate the demonstration in any suitable manner, as embodiments are not limited in this respect. The marketplace service may evaluate various types of credentials that may be provided by a user regarding relationships of the user. In some embodiments, as discussed below, the marketplace service may receive and evaluate a domain of a user's email address to determine whether a user has an existing relationship. In some embodiments, the marketplace service may additionally or alternatively query a social networking service to determine whether a user is connected to another particular user or to a particular group (e.g., whether the social networking service indicates that a user is “friends” with another particular user or group, or indicates that a user “likes” another user or group). As another example, the marketplace service may additionally or alternatively receive input from a second user indicating that the user has the existing relationship. The second user may already be associated with the on-line marketplace that the user wishes to join. The second user may provide the input in any suitable manner, such as by providing input vouching for the user after the user has requested to associate with an on-line marketplace or by inviting the user to join the on-line marketplace and thereby triggering the association process. Embodiments that request demonstrations from users of existing relationships are not limited to receiving and evaluating any particular demonstration of the relationships.

In some embodiments, a marketplace service may manage multiple on-line marketplaces that are independent from one another and managed separately by the service. In other embodiments, the marketplace service may manage a hierarchy of on-line marketplaces, with one or more marketplaces arranged in the hierarchy below another marketplace. The marketplace that is higher in the hierarchy may be a marketplace group and may be linked to one or more marketplaces that are below the marketplace group in the hierarchy. The information distributed in marketplaces by the marketplace service may also be distributed in any marketplace groups that the marketplaces are hierarchically linked to, and users of the marketplace service who are associated with marketplaces may also be associated with marketplace groups with which the marketplaces are associated. A marketplace group may be linked with any suitable set of marketplaces, as embodiments are not limited in this respect. In some cases, a marketplace group may include marketplaces that are related in some manner, such as that there is a relationship between the existing relationships with which the individual marketplaces are associated. For example, in a case in which multiple marketplaces are each associated with a relationship that is employment by a business, and these businesses are located in the same building, a marketplace group may be defined for the building that is linked to each of the marketplaces for the businesses. As another example, in a case in which multiple marketplaces are each associated with a relationship that is membership in a local chapter of an organization, and there is a regional or national organization with which the local chapters are affiliated, a marketplace group may be defined for the regional/national organization that is linked to each of the marketplaces for the local chapters. In some embodiments in which a marketplace service manages a hierarchy of marketplaces, the hierarchy of marketplaces may include two, three, or more levels. In cases in which the hierarchy includes three or more levels, the hierarchy may include marketplace groups that are linked to other marketplace groups. For example, in the case that multiple marketplace groups are defined that each include marketplaces for businesses in a building, and there are multiple buildings in an office park, a marketplace group may be defined for the office park that includes and is linked to each of the marketplace groups for the buildings in the office park.

In some embodiments, to distribute information regarding distribution of an item (e.g., a good or service) in a marketplace, a user may provide information regarding the item to the marketplace service via an interface of the marketplace service. The marketplace service may include any suitable interface for receiving information regarding an item, including a web page interface, as embodiments are not limited in this respect. The information regarding the item may include any suitable information, including a description of the item, a price of the item (e.g., free, for barter or trade, or a monetary value), and/or an image of the item. The information regarding the item may additionally include an indication of the marketplace(s) in which the user wishes the distribute the information regarding the item. The user may be able, via the interface, to select one or more of the marketplaces with which the user is already associated. Upon receipt of the information regarding the item, the marketplace service may store the information in a database or other data store, and may therefore store in the data store information regarding the marketplace(s) in which information regarding the item is to be distributed. Subsequently, the marketplace service may receive from a second user (who may be a different user from the user who provided the information regarding the item) a request to view information that is distributed in a specified marketplace or marketplace group. In response to the request, the marketplace service may retrieve from the data store information regarding the items for which information is to be distributed in the specified marketplace, or in marketplaces linked to the specified marketplace group. The marketplace service may then create, based on the retrieved information, one or more web pages that include the information and transfer the created web pages to a computing device operated by the second user.

In some embodiments, the marketplace service may not be involved in sales of items after distributing information about an item in one or more on-line marketplaces. In other embodiments, however, the marketplace service may enable communication between buyers and sellers about an item or otherwise relating to a sale, and may enable transactions relating to the purchase of items. For example, in some embodiments, the marketplace service may include a messaging facility that receives from a potential buyer a message to be provided to a seller (or vice versa). Upon receipt of the message from a user (e.g., a potential buyer or a seller), the messaging facility may transmit the message to another user (e.g., a potential buyer or a seller) in any suitable manner, as embodiments are not limited in this respect. In some embodiments, the messaging facility may make the message available to the user via an interface of the marketplace service. In other embodiments, the messaging facility may provide the message to a user via a communications protocol external to the marketplace service, such as via e-mail or SMS. Additionally or alternatively, in some embodiments the marketplace service may exchange information relating to a transaction between a buyer and a seller. Information relating to a transaction may include payment information and/or information relating to a delivery of the item from the seller to the buyer. Payment information may, in some embodiments, include information relating to an electronic payment that is to be used by the buyer for purchasing the item from the seller. The electronic payment may be a credit card and/or debit card payment, an Electronic Funds Transfer (EFT), or any other electronic payment. In some embodiments in which the service exchanges payment information, the marketplace service may exchange the information in part by initiating payment transactions upon receipt of payment information from a buyer. For example, the marketplace service may electronically communicate with an electronic payment service (e.g., a service associated with a credit card issuer, or a bank that engages in EFT) to initiate a payment transaction using account information provided by a buyer and/or by a seller. In embodiments in which the marketplace service initiates payment transactions, the marketplace service may initiate the transaction in any suitable manner, including known techniques for initiating payment between buyers and sellers. For example, the marketplace service may communicate via one or more communication networks (e.g., the Internet) to an electronic payment service hosted on one or more servers to initiate a payment transaction.

It should be appreciated that embodiments are not limited to operating with any particular type of users, buyers, and sellers. In some embodiments, a user who posts an item for sale in a marketplace may be the seller, in that the user may own the item and may transfer ownership of the item or otherwise provide the item to a buyer. In other embodiments, a user who posts an item for sale may be an agent for a seller. Similarly, a user may be a buyer or may be an agent for a buyer. In embodiments, buyers and sellers may be individual persons, such that individuals may post items for sale and may purchase the items that are posted for sale. In other embodiments, buyers and sellers may be organizations or other groups of people, such that a buyer and/or a seller may be either a person or an organization. In some cases in which a buyer or a seller is an organization, a user of the marketplace service who posts an item for sale or who purchases an item may be a person acting as an agent for the organization. As mentioned above, embodiments are not limited to operating with any particular types of organizations. Organizations may be for-profit organizations or non-profit organizations, such as businesses, residential associations, educational institutions, hobby groups, or any other suitable organization. Organizations may or may not be legal entities.

### Illustrative Implementation

One embodiment of techniques described herein is the TRADE GROUPER™ system discussed below. It should be appreciated, however, that embodiments are not limited to operating in accordance with the example described below. Other embodiments are possible.

TRADE GROUPER™ provides members with a fully functioning peer to peer ecommerce marketplace service. The marketplace service enables users to distribute information regarding products and services, including by identifying one or more categories for the goods or services. Services may include any suitable services, including rideshare and calendar based housing. The TRADE GROUPER™ system also provides payment options, peer to peer feedback, and a peer to peer message and notification system. Marketplaces are managed by and hosted on the TRADE GROUPER™ servers. The marketplaces can be closed and secure so that only members of a marketplace can view information distributed in the marketplace. Other marketplaces, such as the EGROUPERs™ described below, may be closed and secure or not, at user discretion.

Aspects of the TRADE GROUPER™ Platform, which are described in greater detail below, include:
1. Marketplace credential methods
   a. Credentialed by user's email domain. One or more domains can act as a credential for a single marketplace, where if the member has an email address with one of the domains being used as a filter, the user would be eligible for membership in the marketplace.
   b. Credentialed by confirming a user's social group membership (LinkedIn, FB . . . ). One or more social group memberships can act as a filter for a single marketplace, where if the member is a member of one of the social groups being used as a filter, the user would be eligible for membership in the marketplace.
   c. Credentialed by full email and/or social group ID “Member Created Marketplace”.
      i. Member Created Marketplace administrator has the option to only allow another administrator to invite new members, to allow members that have been invited by an administrator to invite new members or to allow any member of the marketplace to invite members.
2. A marketplace's membership can combine one or more of the credential methods in point 1, where if a member passes one, some, or all of the credential requirements they would be a member of the marketplace.
3. Members can host multiple emails in their TRADE GROUPER™ account to establish eligibility for marketplace memberships based on any of the emails.
4. Marketplaces can be created that combine a location filter to target the membership base. By doing this, the TRADE GROUPER™ platform enables localized marketplaces.
5. Members can administer and/or be members of multiple marketplaces within a single TRADE GROUPER™ account. Listings can be offered to one or more marketplace. Listing inventory is managed centrally so if a sale or rental occurs on one marketplace, the listing's availability is updated across all marketplaces.
6. The TRADE GROUPER™ platform enables organizations and individuals to include an optional percentage of proceeds to be donated to a charity.
7. The TRADE GROUPER™ platform creates individualized one way marketplaces called EGROUPER™ (only the member who created the marketplace can list items) where a member selects items to be distributed via a link that is sent through email or posted to social networks. These marketplaces can be credentialed or non-credentialed.

### The TRADE GROUPER™ Marketplaces Overview

The tradegrouper.com platform hosts peer to peer marketplaces for groups. Each marketplace is a fully functioning ecommerce site with inventory management and the ability to handle payments. Marketplace have customizable product and service categories where members can list items/services for rent, sale, or to be given away. In addition, the platform has plugins that support particular types of goods or services, including a calendar based housing rental section and a dynamic rideshare platform.

All marketplaces are hosted on the TRADE GROUPER™ servers. With the exception of EGROUPER™ marketplaces, all marketplaces are closed and secure so that only credentialed members of that marketplace can view, post or purchase items on the marketplace. Members can be credentialed in several different ways (Single Enterprise marketplaces credential based on email domain and optional location filter, Social Groups credential based on membership in social network groups and Member Created marketplaces credential based on email, social network ID, and SMS. Importantly, marketplaces can also be formed based on the credentialing of multiple or combinations of the Social Group, Member Created and Single Enterprise types.

### EGROUPER™

An EGROUPER™ consist of a system that creates a fully functional ecommerce marketplace for member's to distribute their listings. Unlike other marketplace types mentioned in the previous paragraph, only the sender can post items or services to a specific EGROUPER™. It does not support postings by multiple members. Members can choose any or all the items they have listed in their TRADE GROUPER™ account to be included in their EGROUPER™ marketplace. The EGROUPER™ system also consists of a method for members to send a credentialed or non-credentialed link to a single person or multiple people through the TRADE GROUPER™ platform. The link takes the invitee to the EGROUPER™ marketplace created for the member sending the link and consists of items/services posted by the sender. After sending the EGROUPER™, the member can add or remove inventory and send additional invitations to access the marketplace. Invitations may be distributed via, email, social networks and SMS.

### FIG. 1.0 Sign Up

When a new member signs up on the TRADE GROUPER™ platform at http://tradegrouper.com, the system identifies and stores the user's email address. Users may confirm the email account they are using to sign up before their membership is activated. Email ownership can be confirmed by opening the account using a single sign on like Yahoo, Facebook, Gmail or LinkedIn, where the TRADE GROUPER™ system pulls the user's email address directly from their single sign on account where it has already been verified. In addition, a user may initiate a signup by entering an email into the TRADE GROUPER™ system. In this case, TRADE GROUPER™ sends a verification link that takes the user to a page to complete the signup process by entering their demographic information. Users that signup using a single sign on are taken directly to this form without the need to follow a link.

If the user signs up with an enterprise email account or social email account (e.g., Gmail.com, Yahoo.com, Hotmail.com, etc.), the TRADE GROUPER™ system prompts them to confirm ownership of an enterprise/social email and to confirm enterprise/social group memberships after the signup is complete.

### FIG. 2.0 Sign-In

Once a user has created an account with the TRADE GROUPER™ system, a user may sign in to the system using either an account with a social network (e.g., Facebook or LinkedIn) using known single-sign-on techniques offered by social networking services, or using a username and password associated with the user's TRADE GROUPER™ account via known username- and password-based sign-in procedures. When a user successfully signs in using either option, the user is directed to a “home page” in the TRADE GROUPER™ system.

### FIGS. 3.0-3.2: Marketplace Creation

FIG. 3.0 illustrates different examples of on-line marketplaces that may be used in the TRADE GROUPER™ system. These different examples are discussed separately below.

3.1: EGROUPER™ (and FIG. 3.1)

Members are able to send offers to TRADE GROUPER™ Members and TRADE GROUPER™ non-members via EGROUPER™ invitations. EGROUPER™ invitations can be distributed via the Trade Grouper platform through email, or social networks or SMS. The EGROUPER™ notification contains a link that is credentialed or non-credentialed at the sender's discretion. When links are used to credential a user, TRADE GROUPER™ may verify that the social network ID, email address or SMS address of the user attempting to access the marketplace be the same as the social network ID, email or SMS that is embedded in the invitation, to verify that person to whom the invitation was extended is the person who is using the link. As discussed above, when creating an EGROUPER™, the user may select one, some, or all of the items that user has listed for distribution via the marketplace service, or items that other users have listed for distribution and that are available in the marketplace(s) to which the user has access, to be included in the EGROUPER™.

3.2: Member Created Marketplaces (and FIG. 3.2)

Members are able to create marketplaces on the platform by sending an invitation to join a private marketplace to TRADE GROUPER™ members and TRADE GROUPER™ non-members. Invitations can be sent through social networks, email, or SMS via the TRADE GROUPER™ Platform. Members can verify the credentials embedded in the invitation in order to join the marketplace. In the social network example, the user can verify that their social network ID matches that associated with the invitation and the user who receives their invitation via email or SMS can verify ownership of that email or SMS address. TRADE GROUPER™ accounts can host multiple credentials (email addresses, SMS addresses and social group IDs) so users can add a credential to an existing TRADE GROUPER™ account that does not currently host the credential in order to join a marketplace they have been invited to join.

3.3: Social Groups

If the user verifies membership in social groups using one of the social platform API's to confirm social group membership, marketplaces are created for these social groups (unless they already exist). Membership in a specific social group may give the member access to additional marketplaces, such as marketplace groups.

Users are able to join their enterprise marketplace or social group marketplaces at any time in their Member Home (element 2.3 in FIG. 2.0)

3.4: Single Enterprise

If a user signs up with an enterprise email account (which may be an email account with an employer or another non-personal email account) or confirms their enterprise email account as a secondary email on the TRADE GROUPER™ account, a marketplace is created based on the domain of the email or the user is associated with a marketplace that is based on the domain of the email. The email domain may qualify the user for additional marketplaces that are based on the user's domain and/or user domain/location (zip code) combinations, such as marketplace groups.

3.5: Multi Marketplace

The TRADE GROUPER™ platform enables marketplaces to be created based on membership in or credentialing by a combination of marketplace types. These marketplace types are called Multi Marketplace. A Multi Marketplace type can consist of single or multiple marketplaces of the type discussed with respect to element 3.2 of FIG. 3.0, and/or single or multiple types of the type discussed in connection with element 3.3, and/or single or multiple marketplaces of the type discussed in connection with element 3.4. In addition, a marketplace could combine single or multiple marketplace types discussed in connection with element 3.5 with single or multiple marketplaces of the types described in connection with elements 3.2, 3.3 and/or 3.4.

### FIG. 4.0 Marketplace Administration

There could be one or more members of a marketplace that have administrative rights. Or, Trade Grouper, Inc., could maintain full administrative control over a marketplace with no rights given to members. Administrative rights give members the ability to: be notified of abuse, remove listings, remove membership rights, grant membership rights, appoint other administrators, choose categories and plugins to be included in the marketplace, choose whether the marketplace will have peer to peer feedback enabled, select charity options in term of donation amounts and charity/cause/nonprofit choices and white labeling options.

4.1: EGROUPER™ Marketplaces

The member who creates an EGROUPER™ is given full administrative rights upon creating an EGROUPER™ marketplace. These rights cannot be transferred.

4.2: Member-Created Group Marketplaces

The member who creates a Member Create Marketplace may be, by default, an administrator of the marketplace. The administrator of the marketplace can appoint other members to be full administrators of the marketplace. An administrator may also give limited invitation rights to members on a case by case basis. Or, an administrator may grant invitation rights to a broader group of members. Specifically, an administrator can grant that anyone an administrator has invited can invite people to join the marketplace. The administrator can also set the invitation rules to allow any member of the marketplace to invite additional people to join the marketplace. By offering three levels of invitation settings, the TRADE GROUPER™ platform allows administrators the ability to create marketplaces that are very well controlled and potentially smaller marketplaces that are less controlled but more likely to expand membership.

4.3: Social Marketplaces

Social Marketplaces grant administrative rights to the administrator of the social group if that information is available through the social group API. Administrators may grant others administrative rights or TRADE GROUPER™ may work with a social group membership to assign a social group administrator.

4.4: Enterprise Marketplace

Enterprise marketplaces are established by the email domain of the enterprise. Marketplaces may be created when a member confirms an enterprise with TRADE GROUPER™ for the first time. As marketplaces are created based on email extension, administrators of Enterprise Marketplaces may be appointed by Trade Grouper, Inc. Trade Grouper, Inc., may grant administrative rights on a case by case basis to the person within an organization deemed appropriate by Trade Grouper, Inc.

4.5: Multi Marketplaces

Multi Marketplaces, which may be marketplace groups that are linked to one or more other marketplaces, could be established by Trade Grouper, Inc., or by a Member. The Member who created the Multi Marketplace would be granted administrative rights over the marketplace. Trade Grouper, Inc., will grant administrative rights on a case by case basis to the appropriate person within an organization for the Multi Marketplace it creates.

### FIG. 5.0 Item Creation

Members who list an item may select the appropriate product/service/rental category. Depending on the category, the user may then fill in a number of descriptive fields for the product/service/rental offering. If the member is charging for the product/service/rental, they may provide a price. The member can offer a variety of payment options, which include handling payment offline or having payment sent through the TRADE GROUPER™ platform with PayPal or another third party payment service. The member also has the option to charge for shipping and include shipping and payment notes. If the member offers more than one payment option, the purchaser can select which they would like to use.

Depending on Marketplace settings the member may also select charity options in term of donation amounts and charity/cause/nonprofit to direct the donation. The member may also be able to upload multiple photos.

The member may also select the marketplace(s) in which to list the product/service. The member may choose none or any combination of marketplaces they belong to. The member may also decide whether to include their name with the listing on a marketplace by marketplace basis.

### FIG. 6.0 Notifications

The TRADE GROUPER™ platform sends a number of notifications to members and non-members. Members are able to select the delivery method they prefer for notifications. Notifications include:
a) Signup related notifications
b) Personalized listing alerts based on time, category, location and marketplace
c) Periodic digests with frequency controls and inventory based on category, location, and marketplace
d) EGROUPER™ invitations to members and non-members
e) Invitations to join marketplaces to members and non-members
f) Messaging system for members to contact each other about listings
g) Purchase and sale confirmation
h) Charitable donation receipts
i) Abuse reports for administrators sent to abuse@tradegrouper.com

### FIG. 7.0 Marketplace Examples

The TRADE GROUPER™ platform allows TRADE GROUPER™ to run proprietary marketplace types that enable members to transact with each other in fully functional ecommerce peer to peer platform.

FIG. 7.1 Parent Groups

The Parent Groups example illustrates how the TRADE GROUPER™ platform can be used to create a marketplace hierarchy using the Member Created Marketplace type and the Multi Marketplace type. In this example, a state wide parents' group whose membership is managed at the town level would like to offer its members a marketplace option at both the local level and the state level. By doing this the parents' group would give its members the option to trade with just those in their close community or they could trade with members in a larger community that still has controls at the local level.

Since the state level organization does not have access to the membership at the local level, marketplaces are formed and membership is managed by administrators of each of the local organizations. The state level parents' group (or Trade Grouper, Inc.), creates a marketplace that includes anyone who is a member of one of the local marketplaces. The State level parent organization manages which groups are included and the local organization manages which members are included. Using this functionality, a large organization that has membership managed at the local level could create a marketplace based on local marketplaces. In this way, the trust associated with membership in an affiliated local marketplace would carry forward to create trust in the larger marketplace.

FIG. 7.2 University Alumni and Students

In this example TRADE GROUPER™ or a college would like to create a marketplace that combines the students at a school with alumni of the school. The Single Enterprise type, Social Marketplace type and Multi Enterprise type are used to accomplish this. Students of the school are combined into a marketplace based on the email domain of the school. The alumni of the school are credentialed to an alumni marketplace using Social Marketplace types. TRADE GROUPER™ then uses the Multi Marketplace type functionality to combine the Student Single Enterprise members with the Alumni Social Group members.

FIG. 7.3 Multi-Use District—(Business and Residence)

In this example, TRADE GROUPER™ or a regional transportation district would like to create a marketplace for the employees of the businesses and the residents of the apartment buildings in the district. The Multi Marketplaces type, Member Create Marketplace type, and Single Enterprise Types are used to credential the marketplace. The apartment buildings membership is managed at the apartment building level using Member Created Marketplaces type. The employees of the companies are credentialed using the Single Enterprise Marketplace with location type based on their domain and zip code. The Multi Marketplace functionality is then used to credential based on membership in one of these marketplaces.

FIG. 7.4 Corporation Local Office

TRADE GROUPER™ or a company wants to create local marketplaces for the company's branch offices. This is achieved through Single Enterprise with location functionality. Members are credentialed by email domain and the zip code they have registered in their account. These members have access to both the corporate marketplace (Single Enterprise type) and a marketplace for their local office (Single Enterprise with Location).

FIG. 7.5 Office Park

TRADE GROUPER™ or the owner of an office park wants to create a marketplace for the office park. The office park consists of multiple buildings managed separately and each building contains multiple companies that have more than one location.

To create the marketplace, the Multi Marketplace functionality is combined with Single Enterprise Type with location. Multi Marketplace functionality would combine with Single Enterprise with location to isolate the Office Buildings. Multi Marketplace Functionality would then be used to combine the members of each office building into an office park marketplace. The office buildings could be managed by the building managers while the office park could manage the buildings that are included.

FIG. 7.6 Single Enterprise Networks

TRADE GROUPER™ seeks to form a marketplace consisting of multiple companies. Using Multi Marketplace Types with Single Enterprise Types, employees at multiple organizations with different distinct domains can be combined to create a marketplace. TRADE GROUPER™ manages the TRADE GROUPER™ Corporate Network of approved companies and the TRADE GROUPER™ College Network using this system. Employees or students have access to both a single domain marketplace as well as a networked domain marketplace.

### FIG. 8.0 Member (Mary) Example

Members can host multiple marketplace types in one TRADE GROUPER™ account. Members can also post different items and services to any combination of marketplaces within their account. In addition, inventory is centrally managed. So, if Mary sells her “Clothes” to someone in the Corporate Network, the TRADE GROUPER™ platform removes it from Mary's Office Building, Mary's Employer Company Local Office, Mary's Town Parenting Group and her Garage Sale EGROUPER™.

### EXAMPLE OF A COMPUTING DEVICE

Embodiments are not limited to operating with any particular computing device or type of computing device. FIG. 9 illustrates one exemplary implementation of a computing device in the form of a computing device 900 that may be used to host a marketplace service in a system implementing techniques described herein, although others are possible. It should be appreciated that FIG. 9 is intended neither to be a depiction of necessary components for a computing device to execute an interactive assignment system in accordance with the principles described herein, nor a comprehensive depiction.

Computing device 900 may comprise at least one processor 902, a network adapter 904, and computer-readable storage media 906. Computing device 900 may be, for example, a desktop or laptop personal computer, a server, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by processor 902. Processor 902 enables processing of data and execution of instructions. The data and instructions may be stored on the computer-readable storage media 906.

The data and instructions stored on computer-readable storage media 906 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store computer-executable instructions of a marketplace service 908. The marketplace service 908 may implement one or more of the techniques described above. The storage media 906 may additionally store information 910 regarding goods or services (or any other type of item) that is to be distributed in one or more marketplaces, which may be in the form of a record for each item. The information 910 (e.g., the records for the items) may include, for each good or service (or any other type of item), an indication of the marketplace(s) in which the information 910 is to be distributed. Storage media 906 may also store information 912 regarding marketplaces, which may include information regarding the existing relationship(s) with which each marketplace may be associated, information indicating the users/persons who are permitted to access the marketplace, and/or information indicating that a marketplace is publicly-accessible. As illustrated in FIG. 9, the computer-readable storage media 906 may also store information 914 regarding users, which may include information on existing relationships of users and information on marketplaces with which the user is associated or is eligible to be associated.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method of managing distribution of an item via two or more on-line marketplaces of a marketplace service, the marketplace service managing at least a first plurality of on-line marketplaces, the marketplace service having a plurality of users, the method comprising:
operating at least one processor to:
store in at least one data store, separately for each on-line marketplace of the first plurality of on-line marketplaces, data identifying users of the plurality of users that are permitted to access that on-line marketplace;
receive first input from a first user of the plurality of users identifying a first item to be listed for distribution via the marketplace service and a first on-line marketplace of the first plurality of on-line marketplaces in which to list the first item for distribution;
receive second input from the first user requesting creation of a second on-line marketplace, the second input identifying that at least one second item is to be listed for distribution in the second on-line marketplace and identifying at least one person that does not have access to the first on-line marketplace and that is to be permitted to access the second on-line marketplace, the at least one second item comprising the first item, wherein receiving the second input from the first user comprises:
outputting for display to the first user a listing of one or more second items that the first user has input to the marketplace service to list for distribution via the marketplace service via one or more of the first plurality of marketplaces, and
receiving a selection from the first user of the at least one second item from the one or more second items included in the listing;
store, in the at least one data store, a record for the first item that identifies both the first on-line marketplace and the second on-line marketplace; and
in response to user action relating to the first item within the first on-line marketplace or the second on-line marketplace, update the record in the at least one data store.

2. The method of claim 1, wherein:
receiving the second input requesting creation of the second on-line marketplace comprises receiving an indication that the second on-line marketplace is to be publicly-accessible;
the at least one person comprises a first person who is not one of the plurality of users; and
the method further comprises storing second data in the at least one data store identifying that the second on-line marketplace is publicly-accessible.

3. The method of claim 1, wherein:
receiving the second input further comprises receiving information regarding at least one criteria that is to be used by the marketplace service to determine whether each of the at least one person is permitted access to the second on-line marketplace; and
the method comprises storing, for each person of the at least one person, second data identifying that that person is permitted to access the second on-line marketplace in response to the marketplace service confirming that that person meets the criteria.

4. The method of claim 1, further comprising:
receiving third input from the first user identifying a third item to be listed for distribution via the marketplace service and a third on-line marketplace of the first plurality of on-line marketplaces in which to list the first item for distribution,
wherein receiving the selection from the first user of the at least one second item comprises receiving a selection of at least the first item and the third item from the list, and
wherein the at least one person does not have access to the third on-line marketplace, and
wherein the method further comprises:
storing, in the at least one data store, a record for the third item that identifies both the second on-line marketplace and the third on-line marketplace; and
in response to user action relating to the third item within the second on-line marketplace or the third on-line marketplace, updating the record in the at least one data store.

5. The method of claim 1, wherein storing data identifying users of the plurality of users that are permitted to access an on-line marketplace comprises storing data identifying users who are permitted to view items listed for distribution via the on-line marketplace.

6. The method of claim 1, wherein:
access to the first on-line marketplace of the first plurality of on-line marketplaces is based on a pre-existing relationship between users that is external to the marketplace service; and
the method further comprises storing data indicating that a second user is permitted to access the first on-line marketplace in response to the second user demonstrating to the marketplace service that the second user has the pre-existing relationship with other users that are permitted access to the first on-line marketplace.

7. The method of claim 6, wherein:
the pre-existing relationship between users for the first on-line marketplace is that users permitted access to the first on-line marketplace are associated with an enterprise; and
storing data indicating that a second user is permitted to access the first on-line marketplace in response to the second user demonstrating that the second user has the pre-existing relationship comprises storing the data in response to the second user demonstrating that the second user has an email address having a domain associated with the enterprise.

8. The method of claim 1, wherein:
updating the record in the at least one data store in response to user action comprises updating the record to reflect non-availability and/or reservation of the first item following procurement of the first item by another user within the first on-line marketplace or the second on-line marketplace; and
refraining from listing the first item as available for distribution in any on-line marketplace managed by the marketplace service following the updating.

9. The method of claim 1, wherein:
the first item comprises a collection of multiple items;
updating the record in the at least one data store in response to user action comprises updating the record to change a number of available items of the collection following purchase of some of the multiple items in the collection within the first on-line marketplace and/or the second on-line marketplace; and
following the updating, listing the first item for distribution in the first on-line marketplace and the second on-line marketplace with the updated number of available items.

10. The method of claim 1, further comprising:
receiving third input from a second user, different from the first user, requesting creation of a third on-line marketplace, the third input identifying that the first item is to be listed for distribution in the third on-line marketplace and identifying at least one second person that does not have access to the first on-line marketplace and that is to be permitted to access the third on-line marketplace; and
updating the record for the first item to identify the third on-line marketplace in addition to the first on-line marketplace and the second on-line marketplace.

11. The method of claim 1, wherein the first item to be listed for distribution via the marketplace service comprises an item listed for sale or rent.

12. The method of claim 11, wherein the first item to be listed for sale or rent comprises a good or service.

13. At least one non-transitory computer-readable storage medium having encoded thereon executable instructions that, when executed by at least one computing device, cause the at least one computing device to carry out a method of managing distribution of an item via two or more on-line marketplaces of a marketplace service, the marketplace service managing at least a first plurality of on-line marketplaces, the marketplace service having a plurality of users, the method comprising:
storing in at least one data store, separately for each on-line marketplace of the first plurality of on-line marketplaces, data identifying users of the plurality of users that are permitted to access that on-line marketplace;
receive first input from a first user of the plurality of users identifying a first item to be listed for distribution via the marketplace service and a first on-line marketplace of the first plurality of on-line marketplaces in which to list the first item for distribution;
receive second input from the first user requesting creation of a second on-line marketplace, the second input identifying that at least one second item is to be listed for distribution in the second on-line marketplace and identifying at least one person that does not have access to the first on-line marketplace and that is to be permitted to access the second on-line marketplace, the at least one second item comprising the first item, wherein receiving the second input from the first user comprises:
outputting for display to the first user a listing of one or more second items that the first user has input to the marketplace service to list for distribution via the marketplace service via one or more of the first plurality of marketplaces, and
receiving a selection from the first user of the at least one second item from the one or more second items included in the listing;
storing, in the at least one data store, a record for the first item that identifies both the first on-line marketplace and the second on-line marketplace; and
in response to user action relating to the first item within the first on-line marketplace or the second on-line marketplace, updating the record in the at least one data store.

14. The at least one computer-readable storage medium of claim 13, wherein:
access to the first on-line marketplace of the first plurality of on-line marketplaces is based on a pre-existing relationship between users that is external to the marketplace service; and
the method further comprises storing data indicating that a second user is permitted to access the first on-line marketplace in response to the second user demonstrating to the marketplace service that the second user has the pre-existing relationship with other users that are permitted access to the first on-line marketplace.

15. The at least one computer-readable storage medium of claim 13, wherein:
receiving the second input requesting creation of the second on-line marketplace comprises receiving an indication that the second on-line marketplace is to be publicly-accessible;
the at least one person comprises a first person who is not one of the plurality of users; and
the method further comprises storing second data in the at least one data store identifying that the second on-line marketplace is publicly-accessible.

16. A method of managing distribution of an item via one or more on-line marketplaces of a marketplace service, the marketplace service managing at least a plurality of on-line marketplaces managed by a marketplace service, the marketplace service having a plurality of users, the method comprising:
operating at least one processor to:
receive first input from a first user identifying a plurality of items to be distributed via the marketplace service in one or more of the plurality of on-line marketplaces, the plurality of items comprising a first item, a second item, and a third item;
receive second input from the first user requesting creation of a first on-line marketplace, the second input identifying that the first item and the second item are to be listed for distribution in the first on-line marketplace and identifying at least one first person who is to be permitted access to the first on-line marketplace following creation, wherein receiving the second input from the first user comprises:
outputting for display to the first user a listing of the plurality of items that the first user has listed for distribution via the marketplace service, and
receiving a first selection from the first user of the at least the first item and the second item from the plurality of items included in the listing;
receive third input from the first user requesting creation of a second on-line marketplace, the third input identifying that the second item and the third item are to be listed for distribution in the second on-line marketplace and identifying at least one second person who is to be permitted access to the second on-line marketplace following creation, wherein receiving the second input from the first user comprises:
outputting for display to the first user the listing of the plurality of items that the first user has listed for distribution via the marketplace service, and
receiving a second selection from the first user of the at least the second item and the third item from the plurality of items included in the listing;
send a first message to the at least one first person inviting the at least one first person to access the first on-line marketplace;
send a second message to the at least one second person inviting the at least one second person to access the second on-line marketplace;
store, in at least one data store, a record for the second item that identifies both the first on-line marketplace and the second on-line marketplace; and
in response to user action relating to the second item within the first on-line marketplace or the second on-line marketplace, update the record in the at least one data store.

17. The method of claim 16, wherein:
receiving the second input further comprises receiving information regarding at least one criteria that is to be used by the marketplace service to determine whether each of the at least one first person is permitted access to the first on-line marketplace; and
storing data identifying that the at least one first person is permitted to access the first on-line marketplace comprises, for each first person of the at least one first person, information individually identifying that that first person is permitted to access the first on-line marketplace in response to the marketplace service confirming that that first person meets the at least one criteria.

18. The method of claim 16, wherein:
receiving the second input further comprises receiving an indication that the first on-line marketplace is to be publicly-accessible;
the at least one first person comprises a first person who is not one of the plurality of users; and
the method further comprises storing data in at least one data store identifying that the first on-line marketplace is publicly-accessible.

19. The method of claim 16, further comprising:
storing in at least one data store, separately for each on-line marketplace of one or more of the plurality of on-line marketplaces, data identifying users of the plurality of users that are permitted to access that on-line marketplace, the one or more on-line marketplaces comprising a third on-line marketplace;
receiving, from the first user, fourth input indicating that the second item is to be additionally listed for distribution in the third on-line marketplace of the plurality of on-line marketplaces; and
updating the record for the second item stored in the at least one data store to identify the third on-line marketplace in addition to the first on-line marketplace and the second on-line marketplace.

20. The method of claim 19, wherein:
updating the record in the at least one data store in response to user action comprises, in response to a purchase of the second item within the first on-line marketplace or the second on-line marketplace or the third on-line marketplace, updating the record to reflect non-availability of the second item within the first on-line marketplace, the second on-line marketplace, and the third on-line marketplace; and
the method further comprises, following the updating, refraining from listing the second item as available for distribution in the first on-line marketplace, the second on-line marketplace, and the third on-line marketplace.
